(19) United States
(12) Patent Application Publication
(10) Pub. No.: US 2013/0257826 A1
(43) Pub. Date: Oct. 3, 2013

(54) Liquid Crystal Display and Overdriving Method Thereof

(71) Applicants: Jiande Jiang, Xian (CN); Guangzhi Liu, Shanghai (CN); Chun Wang, Shanghai (CN); Heng Yu, Shanghai City (CN)

(72) Inventors: Jiande Jiang, Xian (CN); Guangzhi Liu, Shanghai (CN); Chun Wang, Shanghai (CN); Heng Yu, Shanghai City (CN)

(21) Appl. No.: 13/550,615

(22) Filed: Jul. 17, 2012

(30) Foreign Application Priority Data
Mar. 31, 2012 (CN) 201210093637.0

(51) Int. Cl. G09G 5/00; G09G 3/36

(52) U.S. Cl. 345/204; 345/87

(57) ABSTRACT

The present invention discloses an overdriving method for a liquid crystal display (LCD). The overdriving method includes steps of dividing a display area of the LCD into a plurality of sub-areas; and driving the sub-areas with a plurality of corresponding overdriving tables according to locations of the sub-areas in the display region. The plurality overdriving tables are corresponding to a plurality of overdriving capability.

### BACKGROUND OF THE INVENTION

1. Field of the Invention

The present invention relates to a liquid crystal display (LCD) and an overdriving method thereof, and more particularly, to an LCD and an overdriving method thereof capable of performing overdriving with different degrees of overdriving capabilities to different locations in a display area of the LCD, to reduce crosstalk between left eye image and right eye image in three-dimensional (3D) image displaying.

2. Description of the Prior Art

With the advance of multimedia technique, the consumers desire not only high quality images but also stereoscopic and realistic three-dimensional images. Working principle of three-dimensional image displaying technique is to present a viewer's left eye and right eye with different images. Because of different angles of view between left and right eyes, images respectively received by left and right eyes by turns are superimposed as a three-dimensional image with depth field and multi-level sense in the viewer's brain.

In general, since a liquid crystal display (LCD) needs a longer reaction time for displaying, when the LCD is desired to be driven to a specific brightness, it requires a specific transition time for charging and thus the LCD can not achieve the brightness immediately. Therefore, a predetermined brightness for displaying a left eye image may be achieved until a right eye image should be displayed, and a predetermined brightness for displaying a right eye image may also be achieved until a left eye image should be displayed, which causes crosstalk between left eye images and right eye images.

In such a situation, the conventional LCD is added with an overdriving mechanism, which performs overdriving with a voltage greater than the voltage for driving the LCD to a predetermined displaying brightness according to an overdriving table, e.g. performing overdriving with the voltage for driving the LCD to a grey scale of 255 when the desired grey scale is 200. Therefore, the predetermined displaying brightness can be achieved within desired periods of displaying left eye image and right eye image, respectively.

However, since a current LCD performs scheduling to a sequence of displaying, e.g. according to scanning order, location of back light, and different scanning mechanism, different locations in an LCD display area are displayed with different length of time, which causes different degrees of crosstalk between left eye image and right eye image, e.g. an upper half part of display area achieves the predetermined displaying brightness more easily since the upper half part starts displaying earlier, and thus there is a lower degree of crosstalk, while a lower half part of display area achieves the predetermined displaying brightness more difficult since the lower half part starts displaying later, and thus there is a higher degree of crosstalk. Therefore, the conventional method of utilizing only one overdriving table can not solve the problem of different degrees of crosstalk in different locations of the display area. Thus, there is a need for improvement of the prior art.

### SUMMARY OF THE INVENTION

It is therefore an objective of the present invention to provide a liquid crystal display (LCD) and an overdriving method thereof capable of performing overdriving with different degrees of overdriving capabilities to different locations in a display area of the LCD, to reduce crosstalk between left eye image and right eye image in three-dimensional image displaying.

The present invention further discloses an overdriving method for an LCD. The overdriving method includes the steps of dividing a display area of the LCD into a plurality of sub-areas; and driving the sub-areas with a plurality of corresponding overdriving tables according to locations of the sub-areas in the display area. The plurality of overdriving tables are corresponding to a plurality of overdriving capability.

The present invention further discloses an LCD. The LCD includes a display area, which comprises a plurality of sub-areas; and an overdriving unit, which divides a display area of the LCD into a plurality of sub-areas; and drives the sub-areas with a plurality of corresponding overdriving tables according to locations of the sub-areas in the display area. The plurality of overdriving tables are corresponding to a plurality of overdriving capability.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of an LCD according to an embodiment of the present invention.

FIG. 1B is a schematic diagram of ratios of overdriving tables utilized in different locations in a display area shown in FIG. 1A.

FIG. 2A is a schematic diagram of a display area in FIG. 1A divided as grids into a plurality of sub-areas.

FIG. 2B and FIG. 2C are schematic diagrams of ratios of overdriving tables utilized in different locations in a display area shown in FIG. 2A.

FIG. 3 is a schematic diagram of an overdriving process according to an embodiment of the present invention.

### DETAILED DESCRIPTION

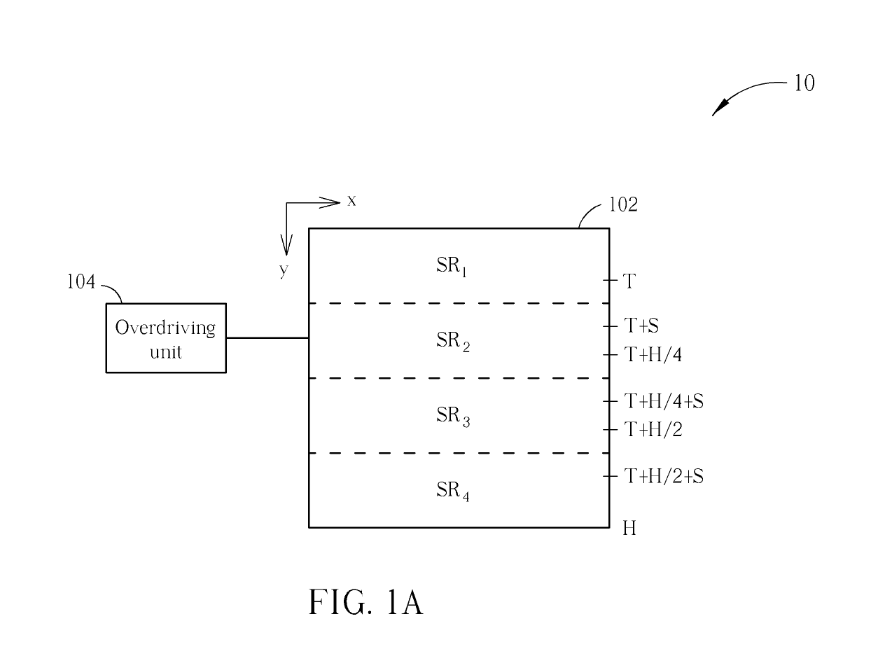

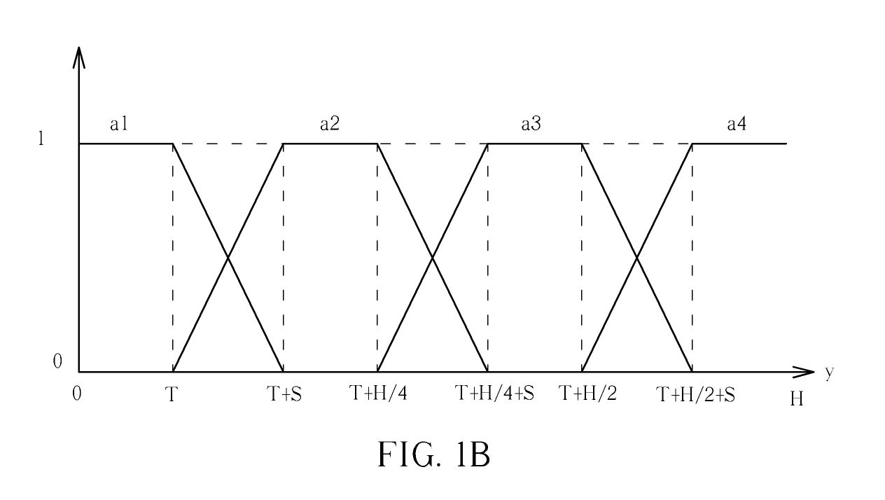

Please refer to FIG. 1A. FIG. 1A is a schematic diagram of a liquid crystal display (LCD) 10 according to an embodiment of the present invention. As shown in FIG. 1A, the LCD 10 includes a display area 102 and an overdriving unit 104. In short, the display area 102 includes sub-areas SR1˜SR4, and the overdriving unit 104 performs overdriving to the sub-areas SR1˜SR4 with corresponding overdriving tables OD1˜OD4 according to locations of the sub-areas SR1˜SR4 in the display area 102. The overdriving tables OD1˜OD4 are corresponding to different overdriving capabilities. As a result, the overdriving unit 104 can perform overdriving with the overdriving tables OD1˜OD4 with different overdriving capabilities, respectively, to the sub-areas SR1˜SR4 with different degrees of crosstalk due to different locations in the display area 102, and thus can effectively reduce crosstalk between left eye images and right eye images in the entire display area 102 when displaying three-dimensional (3D) image.

In detail, since the sub-areas starting displaying later have higher degrees of crosstalk than the sub-areas starting displaying earlier among the sub-areas SR1˜SR4, the overdriving unit 104 can perform overdriving with an overdriving table with a higher overdriving capability to the sub-areas starting displaying later among the sub-areas SR1˜SR4. For example, if the sub-areas SR1˜SR4 are displayed with an up-to-down order of SR1→SR2→SR3→SR4, an order of the corresponding overdriving capabilities with the overdriving tables OD1˜OD4 is OD4>OD3>OD2>OD1. As a result, the present invention performs overdriving compensation with the overdriving tables with different overdriving capabilities to the sub-areas with different degrees of crosstalk, and thus can effectively reduce crosstalk between left eye images and right eye images in the entire display area 102 when displaying three-dimensional image.

Besides, in order to avoid a problem that brightness for displaying an image is discontinuous in a border between two adjacent sub-areas among the sub-areas SR1˜SR4 because the overdriving tables with different overdriving capabilities are utilized in the two adjacent sub-areas, the overdriving unit 104 performs alpha blending to the corresponding overdriving table of the two adjacent sub-areas to generate a mixed overdriving table first, and then performs overdriving with the mixed overdriving table to the border between the two adjacent sub-areas. In such a situation, when the border between the two adjacent sub-areas is closer to one specific sub-area of the two adjacent sub-areas, an overdriving table corresponding to the specific sub-area accounts for a higher ratio in the mixed overdriving table, such that a degree of overdriving performed in the border close to the specific sub-area is more similar to a degree of overdriving performed in the specific sub-area. As a result, the present invention not only effectively reduces crosstalk in different locations of the sub-areas, but also performs blending to overdriving tables corresponding to different sub-areas, so as to perform overdriving to a border between adjacent sub-areas, such that brightness for displaying an image in the border between the different sub-areas can be continuous and smooth.

For example, please refer to FIG. 1B. FIG. 1B is a schematic diagram of ratios a1˜a4 of the overdriving tables OD1˜OD4 utilized in different locations in the display area 102 shown in FIG. 1A, wherein the ratios a1˜a4 are ratios of the overdriving tables OD1˜OD4, respectively, and H is a height of the display area 102. As shown in FIG. 1A and FIG. 1B, within 0 to T along y-axis of the display area 102, since this area is not close to a border between the sub-areas SR1˜SR2 and entirely belongs to the sub-area SR1, the ratio al of the overdriving table OD1 is equal to 1, i.e. the overdriving table OD1 is utilized for performing overdriving in this entire area; then, within T to T+S along y-axis of the display area 102, since the area is the border between the sub-areas SR1˜SR2, overdriving performed in the area is according to a mixed overdriving table blended with the overdriving tables OD1 and OD2, and with more increase along y-axis, the area belongs to the sub-area SR2 more, and the ratio al of the overdriving table OD1 decreases more and the ratio a2 of the overdriving table OD2 increases more, to achieve the brightness continuous and smooth in the border; moreover, within T+S to T+H/4 along y-axis of the display area 102, since the area departs from the border between the sub-areas SR1˜SR2 and entirely belongs to the sub-area SR2, the ratio a2 of the overdriving table OD2 is equal to 1, i.e. the overdriving table OD2 is utilized for performing overdriving in this entire area. By the same token, the present invention can properly adjust the ratios of the overdriving tables OD1˜OD4 utilized for performing overdriving to different locations in the display area 102, i.e. degree of overdriving capability output is OD1*a1+OD2*a2+OD3*a3+OD4*a4. Therefore, the present invention not only effectively reduces crosstalk in different locations of the sub-areas, but also makes the brightness for displaying an image in the border between different sub-areas to be continuous and smooth.

Noticeably, the spirit of the present invention is to perform overdriving with the overdriving tables OD1˜OD4 with different overdriving capabilities to areas with different degrees of crosstalk in the display area 102, so as to effectively reduce crosstalk in the display area 102 when displaying three-dimensional image. Those skilled in the art can make modifications and alterations accordingly. For example, in the above embodiment, the display area 102 is divided into four sub-areas SR1˜SR4, but in other embodiments, the display area 102 can also be divided into other number of sub-areas, which are overdriven with corresponding overdriving tables with different overdriving capabilities. Besides, in the above embodiment, the display area 102 is divided into the sub-areas SR1˜SR4 from up to down, but in other embodiments, the display area 102 can also be divided as grids or divided into a plurality of sub-areas in other forms.

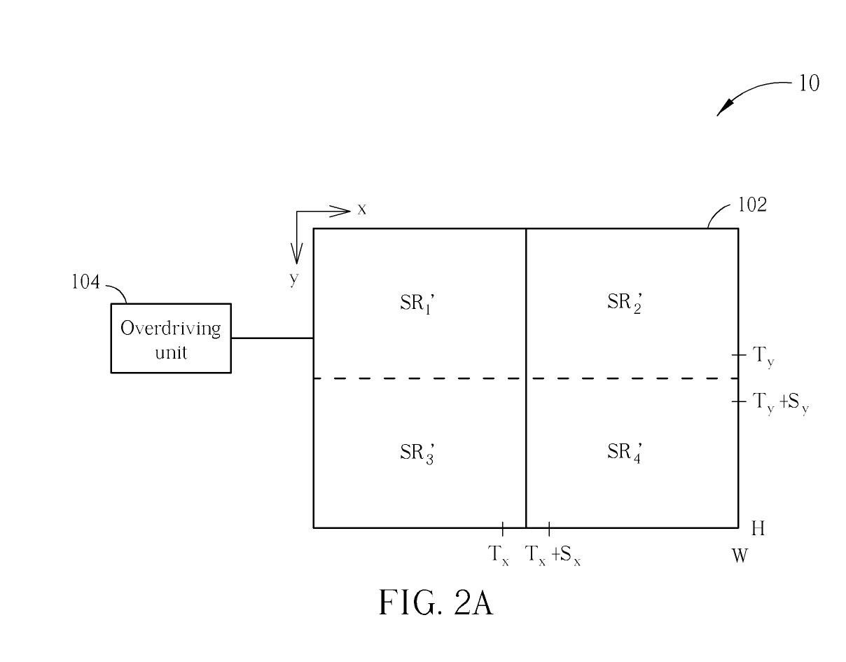

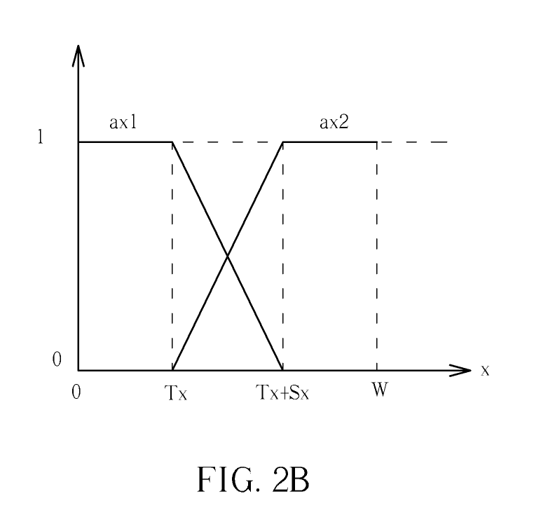

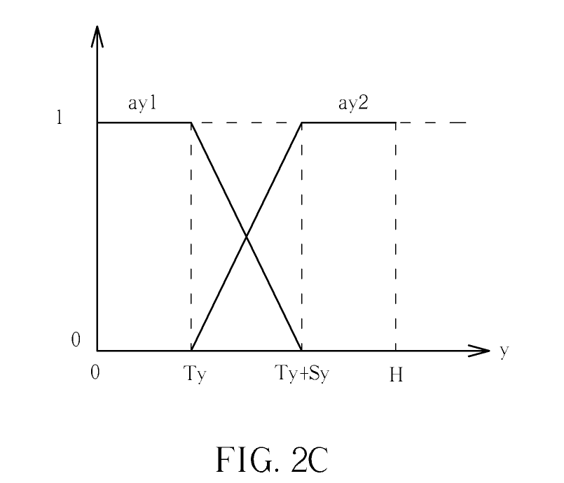

For example, please refer to FIG. 2A to FIG. 2C. FIG. 2A is a schematic diagram of the display area 102 in FIG. 1A divided as grids into sub-areas SR1′˜SR4′, and FIG. 2B and FIG. 2C are schematic diagrams of ratios ax1˜ax2 and ay1˜ay2 of overdriving tables OD1′˜OD4′ utilized in different locations in the display area 102 shown in FIG. 2A, wherein the ratio ax1 is a ratio of overdriving tables OD1′ and OD3′, the ratio ax2 is a ratio of overdriving tables OD2′ and OD4′, the ratio ay1 is a ratio of overdriving tables OD1′ and OD2′, the ratio ay2 is a ratio of overdriving tables OD3′ and OD4′, H is a height of the display area 102, and W is a width of the display area 102.

Under this configuration, similar to the above embodiment, the sub-areas SR1′˜SR4′ are corresponding to the overdriving tables OD1′˜OD4′ with different overdriving capabilities, respectively, and the overdriving unit 104 performs overdriving with an overdriving table with a higher overdriving capability to the sub-areas starting displaying later among the sub-areas SR1′˜SR4′, e.g. if the sub-areas SR1′˜SR4′ are displayed with an up-to-down order of SR1′→SR2′→SR3′→SR4′, an order of the corresponding overdriving capabilities with the overdriving tables OD1′˜OD4′ is OD4′>OD3′>OD2′>OD1′, wherein the overdriving tables OD4′ and OD3′ and the overdriving tables OD2′ and OD1′ are located in the same row, respectively, and thus have similar overdriving capability.

Besides, as shown in FIG. 2B and FIG. 2C, within Ty to Ty+Sy along y-axis of the display area 102, since the area is a border between the sub-areas SR1′ and SR3′, and also a border between the sub-areas SR2′ and SR4′, x-axis is also required to be considered to determine the area is a border between what sub-areas. For example, when x-axis of the display area 102 is less than Tx, the area is determined as the border between the sub-areas SR1′ and SR3′, and thus performed overdriving with a mixed overdriving table blended with the overdriving tables OD1′ and OD3′; when x-axis of the display area 102 is greater than Tx and less than Tx+Sx, the area is determined as the border between the sub-areas SR1′˜SR4′, and thus performed overdriving with a mixed overdriving table blended with the overdriving tables OD1′˜OD4′; when x-axis of the display area 102 is greater than Tx+Sx, the area is determined as the border between the sub-areas SR2′and SR4′, and thus performed overdriving with a mixed overdriving table blended with the overdriving tables OD2′ and OD4′. Similarly, within Tx to Tx+Sx along x-axis of the display area 102, y-axis is also required to be considered to determine the area is a border between what sub-areas. Other operations are similar to the abovementioned case that divides the display area 102 into the sub-areas SR1-SR4 from up to down, and will not be narrated hereinafter. As a result, when dividing the display area 102 as grids into the sub-areas SR1′˜SR4′, the present invention can also properly adjust the ratios of the overdriving tables OD1′˜OD4′ utilized for performing overdriving to different locations in the display area 102, i.e. a degree of overdriving capability is OD1′*ax1+OD2′*ax2)*ay1+(OD3′*ax1+OD4′*ax2)*ay2. Therefore, the present invention can effectively reduce crosstalk in different locations of the sub-areas, and make brightness in borders between different sub-areas continuous and smooth during displaying an image.

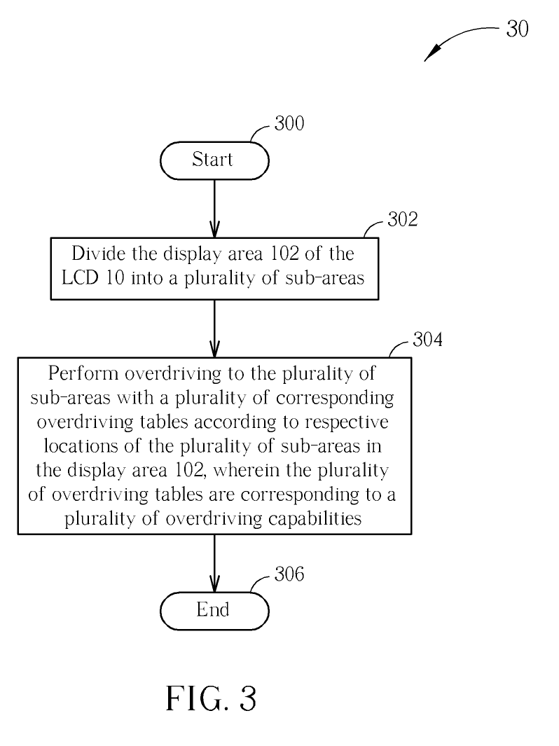

As shown in FIG. 3, the above operating of overdriving for the LCD 10 can be summarized into an overdriving process 30, which includes the following steps:

Step 300: Start.

Step 302: Divide the display area 102 of the LCD 10 into a plurality of sub-areas.

Step 304: Perform overdriving to the plurality of sub-areas with a plurality of corresponding overdriving tables according to respective locations of the plurality of sub-areas in the display area 102, wherein the plurality of overdriving tables are corresponding to a plurality of overdriving capabilities.

Step 306: End.

The detailed operating of the overdriving process 30 can be derived by referring to the above description.

In the prior art, since different locations in an LCD display area are displayed with different length of time, which causes different degrees of crosstalk between left eye image and right eye image, the conventional method of utilizing only one overdriving table can not solve the problem of different degrees of crosstalk in different locations of the display area. In comparison, the present invention performs overdriving with overdriving tables with different overdriving capabilities to areas with different degrees of crosstalk in the display area, so as to effectively reduce crosstalk in the display area when displaying three-dimensional image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An overdriving method for a liquid crystal display (LCD), comprising:
dividing a display area of the LCD into a plurality of sub-areas; and
performing overdriving to the plurality of sub-areas with a plurality of corresponding overdriving tables according to respective locations of the plurality of sub-areas in the display area;
wherein the plurality of overdriving tables are corresponding to a plurality of overdriving capabilities.

2. The overdriving method of claim 1, wherein the step of performing overdriving with the corresponding plurality of overdriving tables according to the respective locations of the plurality of sub-areas in the display area comprises:
performing overdriving with an overdriving table with a higher overdriving capability among the plurality of overdriving tables to overdrive a sub-area displayed later among the plurality of sub-areas.

3. The overdriving method of claim 1, wherein the step of performing overdriving with the corresponding plurality of overdriving tables according to the respective locations of the plurality of sub-areas in the display area comprises:
performing alpha blending to the overdriving tables corresponding to two adjacent sub-areas to generate a mixed overdriving table; and
performing overdriving with the mixed overdriving table to a border between the two adjacent sub-areas among the plurality of sub-areas.

4. The overdriving method of claim 3, wherein when the border between the two adjacent sub-areas is closer to one of the two adjacent sub-areas, an overdriving table corresponding to the one sub-area accounts for a higher ratio in the mixed overdriving table.

5. A liquid crystal display (LCD), comprising:
a display area, comprising a plurality of sub-areas; and
an overdriving unit, for performing overdriving to the plurality of sub-areas with a plurality of corresponding overdriving tables according to respective locations of the plurality of sub-areas in the display area;
wherein the plurality of overdriving tables are corresponding to a plurality of overdriving capabilities.

6. The liquid crystal display of claim 5, wherein the overdriving unit performs overdriving with an overdriving table with a higher overdriving capability among the plurality of overdriving tables to overdrive a sub-area displayed later among the plurality of sub-areas.

7. The liquid crystal display of claim 5, wherein the overdriving unit performs alpha blending to the overdriving tables corresponding to two adjacent sub-areas to generate a mixed overdriving table, and performs overdriving with the mixed overdriving table to a border between the two adjacent sub-areas among the plurality of sub-areas.

8. The liquid crystal display of claim 7, wherein when the border between the two adjacent sub-areas is closer to one of the two adjacent sub-areas, an overdriving table corresponding to the one sub-area accounts for a higher ratio in the mixed overdriving table.
